(19) United States
(12) Patent Application Publication
(10) Pub. No.: US 2005/0234184 A1
(43) Pub. Date: Oct. 20, 2005

(54) Use of polyisobutylene derivatives for treating metal surfaces

(76) Inventors: Georg Josef Doring, Mannheim (DE); Ulrich Karl, Ludwigshafen (DE); Arno Lange, Bad Durkheim (DE); Helmut Witteler, Wachenheim (DE)

Correspondence Address: CONNOLLY BOVE LODGE & HUTZ, LLP, P O BOX 2207, WILMINGTON, DE, 19899, US

(21) Appl. No.: 10/520,983

(22) PCT Filed: Jul. 16, 2003
(86) PCT No.: PCT/EP03/07702

§ 371 Date: Jan. 11, 2005

(30) Foreign Application Priority Data
Jul. 18, 2002 (DE) 102327475

(51) Int. Cl. C08K 3/00

(52) U.S. Cl. 524/543

(57) ABSTRACT

Formulations for treating metal surfaces, especially for corrosion protection, at least comprising a polyisobutylene modified by terminal polar groups and also a solvent or solvent mixture. Process for treating metal surfaces by contacting them with said formulation, and coated metal surfaces.

The present invention relates to formulations for treating metal surfaces, especially for corrosion prevention, at least comprising a polyisobutylene modified by terminal polar groups and also a solvent or solvent mixture. The invention further relates to a process for treating metal surfaces by contacting them with said formulation and to coated metal surfaces.

Metal corrosion poses a problem in the production, processing, and use of articles comprising metals. In order to retard or prevent corrosion, therefore, protective films and/or corrosion inhibitors are used. Whereas a protective film is applied permanently to the metal, a corrosion inhibitor is normally added to substances, such as liquid mixtures, which would cause or accelerate corrosion on contact with the metal. Both the protective films and the corrosion inhibitors may comprise polymers or polymer formulations.

Systems very suitable from a technical standpoint must not only inhibit corrosion but also meet a range of further requirements. For example, they should be capable of being applied uniformly to the metal surface, should exhibit good adhesion to said surface and subsequent finishing layers, and in particular should be capable of being overcoated. Moreover, they are to have a good barrier effect with respect to corrosion-stimulating gases and liquids, sufficient resistance to mechanical stress and to the effects of moisture, especially liquids containing electrolytes, and weathering stability. In addition, the components of the protective films or corrosion inhibitors should be easy to obtain in sufficient quantity and, moreover, should as far as possible be inexpensive.

It is known in principle to use polyisobutylene or derivatives thereof for corrosion prevention. By way of example, Ullmann's Encyclopedia of Industrial Chemistry, 6^{th} Edition, discloses the use of filler-filled high molecular mass polyisobutylene for corrosion prevention.

Polyisobutylene is normally prepared by cationic polymerization using appropriate polymerization catalysts. In the case of the industrial production method which is today still the most widespread, the polymerization catalyst used is AlCl₃. The products normally have a residual chlorine content. The presence of chloride, however, may significantly accelerate the corrosion of metals and is therefore extremely undesirable. In addition, polyisobutylene derivatives prepared starting from a polyisobutylene polymerized using AlCl₃ often have a comparatively high tar content, which is undesirable, especially in aqueous corrosion prevention systems. Moreover, polyisobutylenes prepared using AlCl₃ are normally not homopolymers and contain only a low fraction of reactive α-olefin groups.

EP-A 156 310 discloses the reaction of polyisobutylene with maleic anhydride to give polyisobutylene containing succinic anhydride groups (referred to as PIBSA) and also discloses the use of modified polyisobutylenes of this kind to prepare aqueous and organic corrosion protectants. The degree of functionalization with succinic anhydride groups, however, is only about 60%.

The corrosion-inhibiting effect of PIBSAs of this kind with a low degree of functionalization is inadequate. For instance, EP-A 247 728, EP-A 455 415 and WO 94/03564 describe aqueous and organic formulations which contain PIBSA plus low molecular mass components in order to increase the corrosion prevention effect. Low molecular mass components, however, may be washed out easily in the case of coatings which are subject to weathering. In order to obtain durably effective, weather-stable corrosion prevention formulations it is therefore desirable as far as possible to use no low molecular mass constituents in the formulation, which nevertheless should have as good an effect as possible.

Our earlier application with the file reference DE 101 251 58.0, which was unpublished at the priority date of the present specification, discloses linear polyisobutylene derivatives functionalized at one chain end with terminal polar groups, and their use as corrosion-inhibiting additives, the polar groups being succinic acid radicals which contain a free carboxyl group or salt thereof and also an esterified or amidated carboxyl group.

Our earlier application with the file reference DE 101 476 50.7, which was unpublished at the priority date of the present specification, discloses linear polyisobutylene derivatives functionalized at one chain end with terminal polar groups, and their use as corrosion-inhibiting additives, the polar groups being succinic acid radicals in which at least one carboxyl group is derivatized with polyethylene glycol substituents or with groups containing polyethylene glycol substituents.

It is an object of the present invention to provide formulations for treating metal surfaces which result in at least one of the following improvements to the metal surface: enhanced corrosion prevention, enhanced adhesion for subsequent finishing coats (e.g., painting or metal deposition), passivation, or a smoother surface (on burnishing, pickling or electropolishing).

We have found that this object is achieved by formulations for treating metal surfaces, at least comprising
(a) a polyisobutylene modified by terminal polar groups, obtainable by functionalizing reactive polyisobutylene having a number-average molecular weight Mₙ from 150 to 50 000,
(b) a solvent or solvent mixture capable of dissolving, dispersing, suspending or emulsifying the polyisobutylene derivative, and
(c) optionally, further components,
wherein said polyisobutylene modified by terminal polar groups is one or more selected from the group consisting of
   (A) linear modified polyisobutylene obtainable by functionalizing linear polyisobutylene which is reactive only at one chain end,
   (B) linear modified polyisobutylene obtainable by functionalizing linear polyisobutylene which is reactive at both chain ends, and
   (C) branched modified polyisobutylene obtainable by functionalizing branched polyisobutylene which is reactive at three or more chain ends,
and the degree of functionalization of the chain ends is in each case at least 65%,
where, in the case (A), succinic acid radicals in which at least one carboxyl group is derivatized with polyethylene glycol substituents or with groups containing polyethylene glycol substituents and also succinic acid radicals which contain a free carboxyl group or a salt thereof and an esterified or amidated carboxyl group are excluded as terminal polar groups.

In one preferred embodiment of the invention the formulation is aqueous.

We have also found a process for treating a metal surface which involves contacting said surface with the above-described formulation, and a process for corrosion prevention which involves coating a metallic surface with the above-described formulation.

In a further aspect of the invention, the use of polyisobutylene of the type described at the outset, modified by terminal polar groups, to treat metals has been found.

There now follow details of the invention.

For the formulation of the invention, polyisobutylene derivatives modified by terminal polar groups are used. These may be linear or substantially linear polyisobutylene derivatives which have a polar group only at one chain end. Structures of this kind are also referred to as head-to-tail structures. The derivatives may also be linear or substantially linear polyisobutylene derivatives which have polar groups at both chain ends. Furthermore, it is also possible to use branched polyisobutylene derivatives which contain three or more chain ends having polar groups. The invention is not restricted to a particular branching pattern, although it is preferred to use star-shaped polyisobutylene derivatives, examples being those having three or four arms. Naturally, mixtures of different polyisobutylene derivatives can also be used for the formulation of the invention.

The modified polyisobutylene derivatives are obtainable by functionalizing reactive polyisobutylene starting material. Depending on the nature of the desired polyisobutylene derivatives, the starting material used comprises linear or substantially linear polyisobutylenes which are reactive only at one chain end, linear polyisobutylenes which are reactive at both chain ends, or branched polyisobutylenes which contain three or more reactive chain ends.

The reactive groups at the chain ends may in principle comprise any group, provided they can be suitably reacted to give a terminal polar group. The reactive groups are preferably α- or β-olefin groups and also —C(CH₃)₂—X groups, which can be reacted directly or following elimination by way of the olefin stage. In order to be able to achieve the degrees of functionalization specified at the outset, it is necessary in each case for there to be at least a corresponding amount of reactive chain ends present in the unmodified polyisobutene. Polyisobutene chains having a nonreactive chain end, such as —C(CH₃)═C(CH₃)—CH(CH₃)₂, lack polar modification, are ineffective and/or impair the effect. It is therefore preferred for there to be a relatively large amount of reactive chain ends present.

Preferably, the reactive chain ends are formed, in a manner which is known in principle, in the course of the termination of the polymerization, although it is also possible, albeit not preferred, to provide the chain ends with reactive groups in a separate reaction step.

The degree of functionalization of the modified polyisobutylene derivatives with terminal polar groups is at least 65%, preferably at least 75%, and with very particular preference at least 85%. In the case of the polymers having polar groups only at one chain end, this figure refers only to said one chain end. In the case of the polymers having polar groups at both chain ends, and also in the case of the branched products, this figure refers to the total number of all chain ends. The unfunctionalized chain ends comprise both those which do not have a reactive group at all and those in which a reactive group, although present, is not reacted in the course of the functionalization reaction.

Suitable reactive polyisobutylenes can be obtained, for example, by cationic polymerization of isobutene using BF₃ as catalyst.

For the synthesis of suitable starting materials it is preferred to use isobutene alone. However, cationically polymerizable comonomers may also be used as well. The amount of comonomers, however, should generally be less than 20% by weight, preferably less than 10% by weight, and in particular less than 5% by weight.

Suitable comonomers include principally vinylaromatics such as styrene and α-methylstyrene, C₁-C₄-alkylstyrenes such as 2-, 3-, and 4-methylstyrene, and also 4-tert-butylstyrene, isoolefins having from 5 to 10 carbon atoms, such as 2-methylbut-1-ene, 2-methylpent-1-ene, 2-methylhex-1-ene, 2-ethylpent-1-ene, 2-ethylhex-1-ene, and 2-propylhept-1-ene.

Isobutene feedstocks suitable for synthesizing the starting material include not only isobutene itself but also C₄ hydrocarbon streams containing isobutene, examples being C₄ raffinates, C₄ cuts from isobutene dehydrogenation, C₄ cuts from steam crackers or FCC crackers (FCC: Fluid Catalyzed Cracking), provided they have been substantially freed from 1,3-butadiene present therein. C₄ hydrocarbon streams suitable in accordance with the invention generally contain less than 500 ppm, preferably less than 200 ppm, of butadiene. The presence of but-1-ene, cis- and trans-but-2-ene is substantially uncritical for the process of the invention and does not lead to selectivity losses. The concentration in the C₄ hydrocarbon streams is typically in the range from 40 to 60% by weight. When C₄ cuts are used as feedstock, the non-isobutene hydrocarbons take over the function of an inert solvent.

As catalyst it is possible to use BF₃ alone, its complexes with electron donors, or mixtures thereof. Electron donors (Lewis bases) are compounds which have a free electron pair, on an O, N, P or S atom, for example, and are able to form complexes with Lewis acids. This complexing is desirable in many cases, since it reduces the activity of the Lewis acid and suppresses side reactions. Examples of suitable electron donors are ethers such as diisopropyl ether or tetrahydrofuran, amines such as triethylamine, amides such as dimethylacetamide, and alcohols such as methanol, ethanol, isopropanol or t-butanol. The alcohols additionally act as a source of protons and so initiate the polymerization. A cationic polymerization mechanism may also become active by way of protons from ubiquitous traces of water.

Suitable solvents for the polymerization include all organic compounds which are liquid within the temperature range selected and which neither release protons nor possess free electron pairs. These include, in particular, cyclic and acyclic alkanes such as ethane, isopropane, n-propane, n-butane and its isomers, cyclopentane, and also n-pentane and its isomers, cyclohexane and also n-hexane and its isomers, n-heptane and its isomers, and also higher homologues, cyclic and acyclic alkenes such as ethene, isopropene, n-propene, n-butene, cyclopentene and also n-pentene, cyclohexene and also n-hexene, n-heptene, and aromatic hydrocarbons such as benzene, toluene or the isomeric xylenes. The hydrocarbons may also be halogenated. Examples of halogenated hydrocarbons include methyl chloride, methyl bromide, methylene chloride, methylene bromide, ethyl chloride, ethyl bromide, 1,2-dichloroethane, 1,1,1-trichloroethane, chloroform, and chlorobenzene. Mixtures of the solvents can also be used, provided no unwanted properties occur.

From a technical standpoint it is particularly advisable to use solvents which boil within the desired temperature range. The polymerization normally takes place at from −80° C. to 0° C., preferably from −50° C. to −5° C., and with particular preference from −30° C. to −15° C.

Cationic polymerization with BF₃ produces substantially linear polyisobutenes which have a particularly high α-olefin group content at one chain end. Given an appropriate reaction regime, the α-olefin content is not less than 80%.

Reactive polyisobutylenes which have reactive α-olefin groups at both chain ends or which are branched can be obtained in a particularly elegant fashion by means of living cationic polymerization. Naturally, linear polyisobutylenes which have an α-olefin group only on one chain end may also however, be synthesized by this method.

In the case of living cationic polymerization, isobutylene is polymerized with an appropriate combination of an initiator molecule with a Lewis acid. Details of this method of polymerization are disclosed, for example, in Kennedy and Ivan, “Carbocationic Macromolecular Engineering”, Hanser Publishers 1992.

Suitable initiator molecules IXₙ contain one or more leaving groups X. The leaving group X is a Lewis base, which may also carry yet further substitution. Examples of suitable leaving groups include the halogens fluorine, chlorine, bromine, and iodine, straight-chain and branched alkoxy groups, such as C₂H₅O—, n-C₃H₇O—, i-C₃H₇O—, n-C₄H₉O—, i-C₄H₉O—, sec-C₄H₉O— or t-C₄H₉O—, and also straight-chain and branched carboxy groups such as CH₃CO—O—, C₂H₅CO—O—, n-C₃H₇CO—O—, i-C₃H₇CO—O—, n-C₄H₉CO—O—, i-C₄H₉CO—O—, sec-C₄H₉CO—O—, and t-C₄H₉CO—O—. Connected to the leaving group or groups is the molecular moiety I, which is able to form carbocations I⁺ which are sufficiently stable under reaction conditions. To initiate the polymerization, the leaving group is abstracted by means of an appropriate Lewis acid: I—X+S-->I⁺+XS⁻ (shown here only for n=1). The carbocation formed, I⁺, initiates the cationic polymerization and is incorporated into the resulting polymer. Examples of suitable Lewis acids include AlX₃, TiX₄, BX₃, SnX₄, and ZnX₂, where X stands for fluorine, chlorine, bromine or iodine. The polymerization reaction can be terminated by destroying the Lewis acid, by reacting it with alcohol, for example. This forms polyisobutylene which possesses terminal —C(CH₃)₂—X groups, which can subsequently be converted into α- and β-olefin end groups.

Preferred initiator molecules are structures which are capable of forming tertiary carbocations. Particular preference is given to radicals which derive from the lower oligomers of isobutene, H—[CH₂—C(CH₃)₂]ₙ—X, where n is preferably from 2 to 5. Linear reactive polyisobutylenes formed using such initiator molecules have a reactive group only at one end.

Linear polyisobutylenes which have reactive groups at both ends can be obtained using initiator molecules IXY which have two leaving groups, X and Y respectively, which may be identical or different. Established in the art are compounds which contain —C(CH₃)₂—X groups. Examples include straight-chain or branched alkylene radicals CₙH₂ₙ (in which n can preferably adopt values from 4 to 30), which may also be interrupted by a double bond or by an aromatic component, such as, for example,
X—(CH₃)₂C—CH₂—C(CH₃)₂—Y, X—(CH₃)₂C—CH₂—C(CH₃)₂CH₂—C(CH₃)₂—Y, X—(CH₃)₂C—CH₂—C(CH₃)₂CH₂—C(CH₃)₂CH₂—C(CH₃)₂—Y or X—(CH₃)₂C—CH₂—C(CH₃)₂CH₂—C(CH₃)₂—CH₂—C(CH₃)₂—CH₂-C(CH₃)₂—Y, X—(CH₃)₂C—CH═CH—C(CH₃)₂—Y or para- and/or meta-X—(CH₃)₂C—C₆H₄—C(CH₃)₂—Y.

Branched polyisobutylenes can be obtained using initiator molecules IXₙ which have three or more leaving groups, which may be identical or different. Examples of suitable initiator molecules include X—(CH₃)₂C—C₆H₃—[C(CH₃)₂—Y]—C(CH₃)₂-Z as the 1,2,4 and/or 1,3,5 isomer, the leaving groups preferably being identical although they may also be different. Further examples of mono-, di-, tri- or polyfunctional initiator molecules can be found in the work by Kennedy and Ivan which was cited at the outset and also in the literature cited in that work.

The reactive polyisobutylenes are reacted with appropriate reagents to give the desired polyisobutylene derivatives having terminal polar groups. The number-average molecular weight, Mₙ, of the reactive polyisobutylenes used as starting material for this purpose is from 150 to 50 000, preferably from 200 to 35 000, with particular preference from 300 to 6000, for example, about 550, about 1000 or about 2300.

The term “polar group” is known to the skilled worker. The polar groups may be either protic or aprotic polar groups. The modified polyisobutylene derivatives are composed accordingly of a hydrophobic molecular moiety comprising a polyisobutylene radical and also of terminal groups which have at least a certain hydrophilic character. The groups in question are preferably strongly hydrophilic groups. The terms “hydrophilic” and “hydrophobic” are known to the skilled worker.

Polar groups include, for example, sulfonic acid radicals, carboxyl groups, carboxamides, which may also carry appropriate substitution, OH groups, polyoxyalkylene groups, amino groups, epoxides or suitable silanes.

Suitable reactions for introducing polar groups are known in principle to the skilled worker. Suitable reactions are mentioned by way of example below, in which the reactive groups used on the part of the PIB are α-olefin groups.

Terminal sulfonic acid groups, for example, may be introduced by reacting the reactive PIB with acetyl sulfate, as disclosed, for example, by WO 01/70830.

Amino-terminated derivatives may be obtained by reaction with nitrogen oxides followed by hydrogenation (WO 97/03946).

DE-A 100 03 105 discloses a method of synthesizing PIBs containing primary alcohol groups by hydroformylation. They may also be further alkoxylated with alkylene oxides, preferably ethylene oxide.

Products having phenolic end groups can be obtained by alkylating phenols with PIBs containing α-olefin end groups, using appropriate alkylation catalysts (U.S. Pat. No. 5,300,701; WO 02/26840). These products may also be reacted further, to give Mannich adducts (WO 01/25293; WO 01/25294), for example, or be alkoxylated as described above.

By epoxidation followed by reaction with ammonia it is possible to obtain polyisobutyl amino alcohols (EP-A 476 485). The epoxides can also be used directly, of course.

Furthermore, the PIB may be reacted with maleic anhydride to give polyisobutenylsuccinic anhydride (known as PIBSA), as disclosed, for example, by EP-A 156 310. The reaction produces a new α-olefin group at the chain end, which can be reacted a second time with maleic anhydride to give a product having two succinic anhydride groups at the chain end (known as PIBBSA).

The succinic anhydride groups are already terminal polar groups per se. However, they can also serve as a basis for further functionalization, bearing in mind that, in the case of linear modified polyisobutylene which has polar groups only at one chain end (case (A)), succinic acid radicals where at least one carboxyl group is derivatized with polyethylene glycol substituents or with groups containing polyethylene glycol substituents, and succinic acid radicals which contain a free carboxyl group or a salt thereof and an esterified or amidated carboxyl group, are excluded as terminal polar groups.

By hydrolysis it is possible to form carboxylic acid groups, which can also be converted into salts. Suitable cations in salts include, in particular, alkali metal cations, ammonium ions, and alkylammonium ions.

For further derivatization the succinic anhydride groups may be reacted, for example, with polar coreactants such as alcohols or amines. Suitable polar coreactants are preferably primary alcohols ROH or primary amines RNH₂ or else secondary amines RR′NH, in which R is a linear or branched saturated hydrocarbon radical which bears at least one substituent selected from the group consisting of OH, NH₂, and NH₃⁺, and, if desired, one or more CH(O) groups, and, where appropriate, contains nonadjacent —O— and/or —NH— and/or tertiary —N— groups, and R′, independently of R, has the same definition. Both of the carboxylic acid groups of the succinic anhydride may be reacted or else only one of them, with the other carboxylic acid group being present in the form of a free acid group or in salt form. The above substituents may also be modified still further, by alkoxylation, for example. Additional synthesis variants for the derivatization of succinic anhydride groups are specified in our applications with the references DE 101 251 58.0 and DE 101 476 50.7.

The skilled worker also knows how to convert a succinic anhydride group under appropriate conditions into a succinimide group.

The polyisobutylenes described, modified by terminal polar groups, are used in accordance with the invention to treat metals. They can be used for this purpose as they are, without solvent. For example, suitable derivatives, after gentle heating where appropriate, can be applied to a metallic surface by spraying or pouring.

The formulations of the invention are used with preference, comprising at least one polyisobutylene derivative, an appropriate solvent, and, optionally, further components.

Suitable solvents are those solvents or solvent mixtures which are capable of dissolving, dispersing, suspending or emulsifying the chosen polyisobutylene derivatives. They may be organic solvents or mixtures thereof, or water. Examples of organic solvents include hydrocarbons such as toluene, xylene or mixtures which are obtained, for example, in the refining of crude oil and are obtainable commercially, for example, as petroleum spirit, kerosine, Solvesso® or Risella®. Further examples include ethers such as THF or polyethers such as polyethylene glycol, ether alcohols such as butyl glycol, ether glycol acetates such as butyl glycol acetate, ketones such as acetone, and alcohols such as methanol, ethanol or propanol.

Preferred formulations are those comprising a predominantly aqueous solvent mixture. This term should be understood as including those mixtures which contain at least 50% by weight, preferably at least 65% by weight, and with particular preference at least 80% by weight of water. Further components are water-miscible solvents. Examples include monoalcohols such as methanol, ethanol or propanol, higher alcohols such as ethylene glycol or polyether polyols, and ether alcohols such as butyl glycol or methoxypropanol.

Particular preference is given to formulations comprising water as solvent. The pH of an aqueous solution is determined by the skilled worker in accordance with the nature of the desired application.

The amount of the modified polyisobutylene derivative emulsified, suspended, dispersed or dissolved in the solvent is determined by the skilled worker in accordance with the nature of the derivative and in accordance with the desired application. Generally speaking, however, the amount is between 0.1 to 500 g/l, preferably from 0.5 to 100 g/l, and with particular preference from 1 to 50 g/l, without any intention that the invention should be restricted to these figures. These figures relate to a ready-to-use formulation. Naturally, it is also possible to manufacture concentrates, which are diluted to the desired concentration on site only before actually being used.

Modified polyisobutylene derivatives having a very high degree of functionalization are used for the formulations of the invention. The degree of functionalization with terminal polar groups is at least 65%, preferably at least 75%, with particular preference at least 85%, and with very particular preference at least 90%.

The number-average molecular weight Mₙ of the polyisobutylene radical of the modified polyisobutylene derivatives is from 150 to 50 000, preferably from 200 to 35 000, and with particular preference from 300 to 6000.

Products used for the formulations of the invention are preferably those in which the ratio of the number-average molecular weight Mₙ of the PIB radical to the average number of terminal polar groups present per molecule is from 300 to 5000. The ratio is preferably from 300 to 3000 and with particular preference from 400 to 1000. The latter range is regularly advisable in the case of aqueous systems in particular.

The derivatives of the invention are prepared using preferably polyisobutenes which have a polydispersity (M_{w}/Mₙ) between 1.05 and 20, more preferably between 1.1 and 5, and with particular preference between 1.2 and 2.

The formulations of the invention may additionally comprise further components.

Further components may be, for example, dispersing auxiliaries, emulsifiers or surface-active compounds. Examples include cationic, anionic, zwitterionic, and nonionic surfactants, such as, for example, alkyl alkoxylates containing ethylene and/or propylene oxide units.

The formulations may also comprise additional corrosion inhibitors, such as butynediol, benzotriazole, aldehydes, amine-carboxylates or suitable phosphoric esters, for example.

It is additionally possible, for example, to use pigments, examples being conductivity pigments such as carbon black, graphite or iron phosphide or anticorrosion pigments such as zinc phosphates or calcium phosphates. These auxiliaries and additives are generally present in a finely divided form, i.e., their average particle diameter is generally from 0.005 to 5 μm.

Furthermore, it is also possible to use further polymers, provided that no unwanted properties arise. Examples include acrylates, styrene acrylics, and epoxides.

In the process of the invention for treating metal surfaces, a metal surface is contacted with the formulation of the invention by spraying, dipping or coating, for example. The processes in question may comprise, for example, rust removal, paint stripping, metal pickling, electropolishing or corrosion protection. It is preferred to use the formulations of the invention in processes for corrosion protection.

The process may in particular be a process for corrosion protection in which a metallic surface is coated with the formulation of the invention. The solvent present in the formulation of the invention is substantially removed, by simple evaporation, for example, to leave on the metal surface an impervious, surface-protecting film comprising the modified polyisobutylene derivative or derivatives and also, where appropriate, other components present in the formulation. The polymer film may of course still contain solvent residues.

The thickness of such polymer films on metallic surfaces is chosen by the skilled worker in accordance with the desired properties. Generally speaking, however, even surprisingly thin coats are sufficient to provide the desired corrosion protection effects.

Following the application of the first protective film, the metal surface can be provided with further coverings, of paint or other coatings, for example. The application of the coverings takes place in accordance with techniques known to the skilled worker.

Metal surfaces suitable for application of the formulation according to the invention generally comprise standard industrial materials selected from the group consisting of alloys of aluminum and of magnesium, iron, steel, copper, zinc, tin, nickel, chromium, and standard industrial alloys of these metals. Further suitable metal surfaces include noble metals, especially gold and silver and their alloys. Also suitable, in general, are standard industrial metal coatings, which may be prepared chemically or electrochemically, selected from the group consisting of zinc and its alloys, preferably metallic zinc or zinc/iron, zinc/nickel, zinc/manganese or zinc/cobalt alloys, tin and its alloys, preferably metallic tin or alloys of tin containing Cu, Sb, Pb, Ag, Bi, and Zn, with particular preference those which are used as solders, in the production and processing of circuit boards, for example, and copper, preferably in the form in which it is used on circuit boards and metallized plastic moldings.

The formulations of the invention can be used to treat metal surfaces which have not been pretreated. Preferably, however, the metal surfaces are cleaned before the treatment. Cleaning in this case preferably embraces, inter alia, a degreasing of the metal surface. Appropriate cleaning or degreasing techniques are known to the skilled worker. It is also possible to use the composition of the invention in a process step subsequent to a pickling or passivating treatment of the metal surface—in a coating step, for example. The formulations of the invention may also be used as cleaning, pickling, and polishing formulations, which may include additives known to the skilled worker and may be used in appropriate processes.

The process of the invention may comprise, for example, the following steps:
(a) where appropriate, cleaning the metal surface to remove dirt, fats or oils,
(b) where appropriate, washing with water,
(c) where appropriate, pickling to remove rust and other oxides, in the absence or presence of the formulation of the invention,
(d) where appropriate, washing with water,
(e) treating the metal surface with the composition of the invention,
(f) where appropriate, washing with water, and
(g) where appropriate, aftertreating, in the absence or presence of the composition of the invention.

The treatment of the metal surface may comprise, for example, an operation of coating with the composition of the invention. Preferably, a drying step is carried out thereafter.

The treatment in question may also be a passivating treatment, in particular a phosphating treatment, by methods known to the skilled worker. In one preferred embodiment the formulation of the invention comprises one or more elements selected from the group consisting of Ce, Ti, Zr, Hf, V, Fe, Co, Ni, Zn, Ca, Mn, Cr, Mo, W, Si, and B. Preference is given to Cr(III) salts, chromates, molybdates, and tungstates, and also fluorometallates of Ti(IV), Zr(IV), Hf(IV), and Si(IV), in acidic formulation. Washing with water takes place between the process steps in order to prevent any contamination of the solution used for the next step in each case by the preceding solution. It is, however, also possible to forego one, two or all of the washing steps (b), (d) and (f).

Following the process steps (a) to (g), the metal surface may further be provided with a coating material, for example:

Corrosion protection layers with the application of the composition of the invention exhibit very good adhesion to metallic surfaces and to subsequent finishing coats and impart lasting corrosion protection. They are stable to weathering and to being washed out.

The following experiments are intended to illustrate the invention:

For the corrosion tests the following PIB derivatives were used:

### EXAMPLE 1

Modified Polyisobutylene with High Degree of Functionalization

Starting Material:

The starting material used was a commercial polyisobutene having an average molar mass Mₙ of 550 g/mol (PIB₅₅₀) prepared by cationic polymerization of isobutene with catalysis by BF₃ (Glissopal® 550, BASF AG). The α-olefin group content as determined by ¹³C NMR was 88%, the β-olefin group content 6%, and the molar weight distribution M_{w}/Mₙ 1.35.

1. Reaction of PIB₅₅₀ with Phenol

6.4 mol of phenol were dissolved in 580 g of toluene in a stirred apparatus. 0.291 mol of BF₃-phenol was added and the mixture was stirred at 25° C. under N₂. Then 3.2 mol of the abovementioned PIB₅₅₀ were metered in over the course of 6 h at 20 to 25° C. and the mixture was subsequently stirred at RT for 17 h. The contents of the reactor were deactivated with 1 l of methanol and then about ½ l of water was added. Following phase separation 4-PIB-phenol was separated off and washed with twice 0.5 l of methanol.

2. Reaction of PIB₅₅₀-Phenol with POCl₂

A 4 l four-necked flask with stirrer, reflux condenser, bubble counter and wash bottle was flushed with nitrogen and then charged with 690 g of POCl₃ and 3 g of AlCL₃ at room temperature, and this initial charge was heated to 90° C. 1930 g of the PIB₅₅₀-phenol obtained in 1 were initially dissolved in 750 ml of heptane and the solution was added over the course of about 70 minutes at from 90 to 100° C. Significant evolution of gas was observable. After the end of the addition, stirring was continued for about 1 h at from 95 to 105° C. After cooling to room temperature, the contents of the flask were transferred to a round-bottomed flask and excess POCl₃ and heptane were removed by distillation on a rotary evaporator at 100° C. and 100 mbar, to give PIB₅₅₀-phenoxy-POCl₂.

3. Reaction of PIB₅₅₀-Phenoxy-POCl₂ to Give PIB₅₅₀-Phenoxy-Phosphoric Acid

The apparatus described above was charged with 2050 g of the above-obtained PIB₅₅₀-phenoxy-POCl₂ in solution in 1500 ml of heptane. Added dropwise thereto over the course of 25 minutes at from 20 to 30° C. was a mixture of 97.2 g of water and 400 ml of THF. Finally the mixture was heated to 60° C. and left to react for 30 minutes. After cooling to room temperature the contents of the flask were transferred to a round-bottomed flask and solvent and water were distilled off on a rotary evaporator at an end temperature of 100° C. and an end pressure of 5 mbar. This gave PIB₅₅₀-phenoxy-phosphoric acid. By means of 1H NMR a degree of functionalization of 94% was found.

### EXAMPLE 2

Purification of the PIB₅₅₀-Phenoxy-Phosphoric Acid Obtained in Accordance with Example 1

100 g of the PIB₅₅₀-phenoxy-phosphoric acid obtained in accordance with example 1 were dissolved in 1 l of heptane and extracted by shaking with twice 500 ml of water in a separating funnel. The organic phase was dried using Na₂SO₄ and filtered and heptane was stripped off on a rotary evaporator. The product was dissolved in 250 ml of xylene and the solvent was stripped off on a rotary evaporator. This operation was repeated one more time. The purified product contained only about 10 ppm of inorganic Cl.

### COMPARATIVE EXAMPLE 1

Modified Polyisobutylene with Low Degree of Functionalization

The starting material used was a polyisobutene having an average molar mass Mₙ of 1000 g/mol (PIB₁₀₀₀) prepared by cationic polymerization with catalysis by AlCl₃. The product has an α-olefin group content of 9%. (Hyvis® 10, BP Chemicals).

1. Reaction with Maleic Anhydride to Give PIBSA

In a manner known in principle 200 g of the abovementioned PIB₁₀₀₀ together with 25 g of maleic anhydride were charged to a stirred autoclave. After flushing with nitrogen the system was heated to 220° C. (under autogenous pressure, about 1.2 bar) and the autoclave was held at this temperature for 4 h. After cooling, the autoclave was let down. This gave PIBSA₁₀₀₀.

A sample of the batch was freed from unreacted maleic anhydride and low molecular mass cleavage products, using acetone, and a 1H NMR was prepared. The ratio of the integrals of the terminal t-butyl group and the protons of the succinic anhydride indicates a degree of functionalization of 63%.

2. Reaction of PIBSA₁₀₀₀ with Polyethylene Glycol

120 g of the resultant PIBSA₁₀₀₀ were charged to a stirred apparatus and 72 ml of toluene were added. The solution was heated to 50° C. and 44 g of polyethylene glycol (average molar mass Mₙ 400 g/mol) were added dropwise. The mixture was subsequently heated at 120° C. for 30 minutes and at 135° C. for 45 minutes. After cooling and transfer the solvent, finally, was stripped off on a rotary evaporator at 140° C. and an end pressure of 5 mbar. The reaction gave a PIB-succinic acid monoester.

Corrosion Tests:

General Operating Instructions:

The metal test panels (2 cm×5 cm, 1.0037 steel) are pretreated by cathodic alkaline degreasing and subsequent electrolytic derusting.

1% strength solutions (amount in % by weight) in THF were prepared using the modified polyisobutylene derivatives described above, and the steel plaques were placed in this solution for 30 minutes. Subsequently the plaques were rinsed off with THF and blown dry with nitrogen.

The steel plaques treated with the PIB formulation were covered with a test solution of 0.2% by weight NaCl in water (pH 7) in a sealed screw-top glass vessel and stored in the sealed screw-top glass vessel for 1 week. The contents of the vessel were thoroughly mixed once daily by shaking.

In addition to the experiments described, a comparative experiment with an untreated steel panel was carried out as well, as a blank sample.

The corrosion control efficiency is indicated by comparing the loss of mass of the metal panels tested with and without PIB coating.
Efficiency [%]=[(ΔM₀−ΔM)/(ΔM₀)]*100.
ΔM₀: loss of mass of the panel without PIB derivatives
ΔM: loss of mass of the panel with addition of PIB derivatives

Determination was carried out in duplicate in each case and the mean value from the two experiments was formed. The results of the experiments are contained in table 1.

TABLE 1
Results of inventive and comparative experiments.

| | | Corrosion |
|---|---|---|
| Experiment | Type of | control |
| No. | polyisobutylene | efficiency |
| Experiment 1 | PIB with high degree of | +3.5% |
| | functionalization, phosphoric | |
| | acid end groups | |
| Experiment 2 | PIB with high degree of | +5.6% |
| | functionalization, phosphoric | |
| | acid end groups, purified | |
| Comparative | PIB with low degree of | −3.5% |
| experiment 1 | functionalization, | |
| | PEG end group | |
| Comparative | Blank sample, no PIB added | 0 |
| experiment 2 | | |

The experiments show that the corrosion resistance of the steel panel increases through treatment with an inventive formulation in comparison to an untreated steel panel.

Treatment with a noninventive formulation of a PIB derivative with a low degree of functionalization results in fact in a decrease in the corrosion resistance, by contrast.

1. A process for treating metal surfaces, in which the metal surface is contacted with a formulation which comprises at least
(a) a polyisobutylene modified by terminal polar groups, obtainable by functionalizing reactive polyisobutylene having a number-average molecular weight Mₙ from 150 to 50 000,
(b) water or a solvent mixture containing at least 50% by weight of water, which is capable of dissolving, dispersing, suspending or emulsifying the polyisobutylene derivative, and
(c) optionally, further components,
wherein the reactive polyisobutylene used as starting material is prepared using BF₃ as catalyst or by means of living cationic polymerization and the polyisobutylene modified by terminal polar groups being one or more selected from the group consisting of
(A) linear modified polyisobutylene obtainable by functionalizing linear polyisobutylene which is reactive only at one chain end,
(B) linear modified polyisobutylene obtainable by functionalizing linear polyisobutylene which is reactive at both chain ends, and
(C) branched modified polyisobutylene obtainable by functionalizing branched polyisobutylene which is reactive at three or more chain ends,
and the degree of functionalization of the chain ends is in each case at least 65%,
where, in the case (A), succinic acid radicals in which at least one carboxyl group is derivatized with polyethylene glycol substituents or with groups containing polyethylene glycol substituents and also succinic acid radicals which contain a free carboxyl group or a salt thereof and an esterified or amidated carboxyl group are excluded as terminal polar groups.

2. A process as claimed in claim 1, wherein the degree of functionalization is at least 75%.

3. A process as claimed in claim 1, wherein the degree of functionalization is at least 85%.

4. (canceled)

5. A process as claimed in claim 1, comprising the steps of:
(a) optionally, cleaning the metal surface to remove dirt, fats or oils,
(b) optionally, washing with water,
(c) optionally, pickling to remove rust and other oxides, in the absence or presence of the formulation of the invention,
(d) optionally, washing with water,
(e) treating the metal surface with the composition of the invention,
(f) optionally, washing with water, and
(g) optionally, aftertreating, in the absence or presence of the composition of the invention.

6. A metallic surface comprising at least one coating comprising a polyisobutylene modified by terminal polar groups and also, optionally, further components, obtainable by a process as claimed in claim 1, followed by removal of the solvent.

7. A process as claimed in claim 3, comprising the steps of:
(a) optionally, cleaning the metal surface to remove dirt, fats or oils,
(b) optionally, washing with water,
(c) optionally, pickling to remove rust and other oxides, in the absence or presence of the formulation of the invention,
(d) optionally, washing with water,
(e) treating the metal surface with the composition of the invention,
(f) optionally, washing with water, and
(g) optionally, aftertreating, in the absence or presence of the composition of the invention.

8. A metallic surface comprising at least one coating comprising a polyisobutylene modified by terminal polar groups and also, optionally, further components, obtainable by a process as claimed in claim 7, followed by removal of the solvent.

9. A process as claimed in claim 1, wherein said solvent mixture containing at least 65% by weight of water.

10. A process as claimed in claim 1, wherein said solvent mixture containing at least 80% by weight of water.

11. A process as claimed in claim 1, wherein the degree of functionalization is at least 90%.

12. A process as claimed in claim 1, wherein said polyisobutylene has a number-average molecular weight Mₙ from 200 to 35,000.

13. A process as claimed in claim 1, wherein said polyisobutylene has a number-average molecular weight Mₙ from 300 to 6,000.

14. A process as claimed in claim 1, wherein the terminal polar group is a group selected from the group consisting of sulfonic acid residues, carboxyl groups, carboxamide groups, OH groups, polyoxyalkylene groups, amino groups, epoxides and silanes.

15. A process as claimed in claim 1, wherein the terminal polar group is a succinic anhydride group.

16. A process as claimed in claim 15, wherein the succinic anhydride group is further functionalized with a polar reactant.

17. A process as claimed in claim 1, wherein the terminal polar group is a phenoxyphosphoric acid group.
